(19) United States
(12) Patent Application Publication
(10) Pub. No.: US 2007/0288349 A1
(43) Pub. Date: Dec. 13, 2007

(54) METHOD AND SYSTEM FOR FACILITATING SECURED COMMERCIAL TRANSACTIONS THROUGH TRUSTED AGENTS

(75) Inventor: Luis Chang, Englewood, NJ (US)

Correspondence Address: L. HOWARD CHEN;KIRKPATRICK & LOCKHART PRESTON GATES ELLIS, LLP, 55 SECOND STREET, # 1700, SAN FRANCISCO, CA, 94105, US

(73) Assignee: Luichi Holding Company Limited

(21) Appl. No.: 11/745,369

(22) Filed: May 7, 2007

Related U.S. Application Data
(60) Provisional application No. 60/798,898, filed on May 8, 2006.

(51) Int. Cl. G06Q 40/00

(52) U.S. Cl. 705/37

(57) ABSTRACT

The present invention discloses a member-based trade management system for facilitating trade among consumers and producers by utilizing an agent service. The system comprises a network-based communications module for storing and providing profile information about consumers, producers, and third-party service providers; a member matching service module for presenting candidates for a transaction group; a member research service module for examining credentials of candidates for the transaction group; a transaction service module for tracking a transaction workflow; a financial service module for ensuring exchange of financial values between consumers and producers; a platform management service module for mediating disputes arising from activities related to the trade transaction; and one transaction service facilitation unit for allowing consumer and producer agents to access data in the trade platform, wherein the customer and producer agents, located in close proximity of the customers and producers, to facilitate the completion of the trade transaction.

### CROSS REFERENCE

The present application claims the benefit of U.S. Provisional Application Ser. 60/798,898, which was filed on May 8, 2006.

### BACKGROUND

The advent of the Internet and the convergence of advanced database and communications technologies have provided the opportunity to re-evaluate the way trade, especially international trade, for consumer manufactured goods is conducted.

For the last hundred years, the most significant advancement in the manufacturing and trade arenas has been the speed: the speed of transactions, manufacturing, shipping, data transfer, etc. However, the mechanisms of trade have not changed substantially. Agents or middlemen still control access and contact between the actual source of the goods and the ultimate buyer of the goods. Financing for transactions remains an issue: cumbersome regardless of the current solution employed. The resources available for establishing a sourcing network far away are very different from 200 years ago. However, the entire flow of trade transactions involving parties located remotely are still complicated and it remains difficult to be conducted directly by the participants. As a result, even with the advancements in communications technologies and the convenience of travel, a professional class of traders remains in control of trade transactions, especially for those with cross border in nature.

The existing trading model puts the interests of the middleman before those of the two key players in a trade transaction—the the consumer and the producer. The process of generating a “deal” and insulating the consumer from the producer takes precedence over smooth, open communication and a high quality transparent transaction.

Recent attempts to use the Internet to improve how trade is conducted have similarly focused on the speed of generating a transaction rather than seeking to improve the quality of the transaction. In fact, these recent efforts have created a lot of problems. Information can now be easily exchanged electronically, but anonymous matching systems or simple advertisement-based listings are easily manipulated for fraudulent purposes. International banking is increasingly computerized and straightforward, yet the process for payment in a trade transaction remains almost unchanged in the last 60 years. The ability to physically visit and meet with geographically dispersed suppliers has never been easier, yet language, currency and payment issues as well as the lack of standard transaction format and terminologies limit the speed and efficiency of conducting trade transactions.

Also, parties to a trade transaction are in much need of using trusted agents who can help to deal with various issues in the transaction due to the complexities of the transaction, especially when the buyer and the producers are located in different geographical regions. What many online matching mechanisms are missing is an arrangement of professional agents who will facilitate the transaction for the benefits of the buyer, not the producer. What is needed is a trading platform with trusted agents for facilitating trade by focusing on the needs of the consumers through a global communications network so that parties admitted to the platform are trusted by others to join in a trade transaction.

### SUMMARY

The present invention discloses a member-based trade management system for facilitating trade among consumers and producers by utilizing an agent service. The system comprises a network-based communications module for storing and providing profile information about consumers, producers, and third-party service providers; a member matching service module for presenting candidates for a transaction group; a member research service module for examining credentials of candidates for the transaction group; a transaction service module for tracking a transaction workflow; a financial service module for ensuring exchange of financial values between consumers and producers; a platform management service module for mediating disputes arising from activities related to the trade transaction; and one transaction service facilitation unit for allowing consumer and producer agents to access data in the trade platform, wherein the customer and producer agents, located in close proximity of the customers and producers, to facilitate the completion of the trade transaction.

The construction and method of operation of the invention, however, together with additional objects and advantages thereof, will be best understood from the following description of specific embodiments when read in connection with the accompanying drawings.

### BRIEF DESCRIPTION OF THE DRAWING

The drawings accompanying and forming part of this specification are included to depict certain aspects of the invention. The invention may be better understood by reference to one or more of these drawings in combination with the description presented herein. It should be noted that the features illustrated in the drawings are not necessarily drawn to scale.

FIG. 1 illustrates an architecture view of a trade platform in accordance with one embodiment of the present invention.

FIG. 2 illustrates a process of establishing a membership of the trade platform in accordance with one embodiment of the present invention.

FIG. 3 illustrates a process of completing a trade transaction in the trade platform in accordance with one embodiment of the present invention.

FIG. 4 illustrates a workflow of the trade operation using the system in accordance with one embodiment of the present invention.

### DESCRIPTION

The following detailed description of the invention refers to the accompanying drawings. The description includes exemplary embodiments, not excluding other embodiments, and changes may be made to the embodiments described without departing from the spirit and scope of the invention. The following detailed description does not limit the invention. Instead, the scope of the invention is defined by the appended claims.

The trade platform disclosed in the present invention combines various trading services to create a transparent trade environment facilitated by a transaction service facilitation unit and monitored by a platform management service module. The trade platform includes a communications network (e.g. one based on Internet), a financial service module, member matching and researching service modules, and a transaction service module. Furthermore, the communications network stores trading information and supports real-time communications between the parties. In short, the trade platform provides services and support, which are necessary for supporting remote transactions from initial sourcing through contracting, delivery, and payment, and further ensures the security and quality of the transactions.

Many online matching mechanisms provide platforms for buyers to meet with sellers. Various agents participate in trade transactions usually represent the interest of the sellers, and do not have a vested interest in the buyer for long term. For example, an insurance agent is only interested in selling the insurance products that he presents to the buyer and gets paid. Once the insurance policy is sold, he does not want to be involved in any major way. There is no arrangement of professional agents who will facilitate the transaction for the benefits of the buyer, not the producer, and get compensated based on long term satisfaction of the buyer. With the exception of few people in the consuming population, the majority of the buyers cannot afford the luxury of having professional assistants who can help to facilitate the trade transaction on their behalves. A middleman usually works for the interest of selling the goods or service to the buyer, but does not watch out for the interest of the buyer.

Another major problem for online trading or for trading across two regions (e.g., cross border transactions) is that each party cannot check the credentials of the other due the unfamiliarity with the party caused by the distance therebetween. Unlike trading among family members, there is no mutual trust between the parties, and that is why the only binding way to doing cross border business is to get a bank issued Letter Of Credit.

What the present invention presents is a global trading platform with trusted agents for facilitating trade by focusing on the needs and interests of the consumers through a global communications network so that parties admitted to the platform are trusted by others to join in a trade transaction.

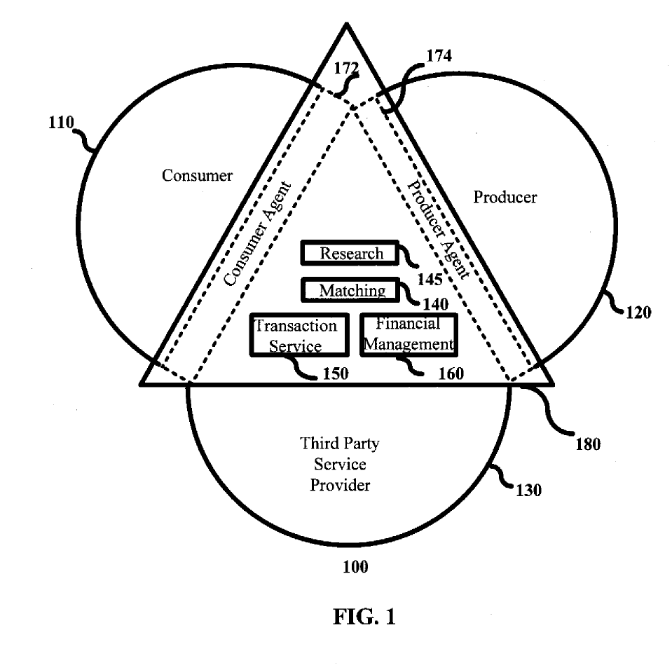

FIG. 1 illustrates an architecture view of the multi-party global trade platform in accordance with one embodiment of the present invention. The trade platform comprises a plurality of business entities, including, for example, one or more consumers 110, a plurality of producers 120, and a plurality of third-party service providers 130. For participating in a trade transaction, an artificial transaction group is formed at least by at least one consumer and at least one producer, one or more agents working for the benefit of the consumer, and possibly one or more third-party service providers.

Transactions among the constituents of a transaction group are facilitated by agents of a transaction service facilitation unit within the trade platform. More specifically, agents of a transaction service facilitation unit seek to protect the consumers of the trade platform. They are categorized as consumer agents 172 and producer agents 174 according to their functions. Typically, a consumer agent 172 locates close to the consumer and has a one-to-one relationship with the consumer, and coordinates all activities with regard to the trade transaction on behalf of the consumer. The producer agent 174 is typically located close to the designated or qualified producer. Based on what transaction the consumer is about to enter into, the consumer agent 172 may, if needed, deal with at least one producer agent 174 who knows about the qualified producer. In some transactions, the consumer agent 172 may deal with the producer directly without involving the producer agent if he is fully satisfied with the credentials of the producer. For example, if the consumer agent has dealt with the same producer in the past and feel comfortable to recommend the consumer to enter into a new trade transaction, the consumer agent may skip using the producer agent. As the consumer agent functions as a “personal assistant” to the consumer, the relationship between them is very important. A mutual trust must be there for them to work closely. As such, the platform (e.g., the transaction service facilitation unit) allows a consumer to choose and change a consumer agent based on his or her preferences.

Consumer agents 172, located in close proximity of their clients, provide one-on-one service to a plurality of consumers to whom they establish long term relationship. More specifically, the consumer agents 172 may meet with their clients face-to-face to understand their needs and resolve any trading issues with regard to any trade transaction that their clients entering into. To facilitate the transactions, they may choose to consult with other professional service providers such as other professional agents who have better domain knowledge in certain areas. For example, the consumer agent may consult with traditional travel agents and insurance agents to satisfy the needs of their clients and coordinate various services. The consumer agents 172 may follow some standardized procedures and practices as dictated by certain policies and rules implemented by the platform, and their primary goal is to protect the interests of the clients by getting them the best deals within the platform. Consistent with this unique requirement, compensations to the consumer agents 172 are determined based on their performance evaluated by clients. For example, a survey will be filled by the consumer after a particular transaction is completed with regard to the performance of the agent, and the survey result will determine largely, although may not be exclusively, how much the agent get paid.

In addition to the consumer agent, producer agents 174 represent the trade platform and monitor the producers 120. For example, they may be monitoring the progress of transactions and the quality of goods or services provided by the producers 120. As they are far closer to the producer than the consumer agent, they can help to deal with various local issues conveniently. For example, they can check the credentials of the selected producer and recommend to the consumer agent in order to move the transaction to the next stage. In the back end of the transaction, they may initiate formal inquires into a producer's conduct when complaints about goods and services provided by such producer has reached a predetermined threshold. In short, the producer agents are the “long arms” of the consumer agents and work with the consumer agents in order to satisfy the interests of the consumer with the metes and bounds of the trade platform.

A plurality of service modules of the trade platform are designed to support business transactions. They include a member matching service module 140, a research service module 145, a transaction service module 150, and a financial service module 160. These modules can be implemented by computer programs located in central or regional servers and accessible through programs implemented on computer based access devices at remote ends. The member matching service module 140 helps to match a consumer with at least one producer and possibly one or more third-party service providers according to predetermined criteria determined by the agents for the consumers, and thus creates an artificial transaction group. Once the transaction group is formed with these constituents, the platform, through various computer programs, creates a transaction flow and provides a transaction flow with various data for monitoring the progress of the transaction. The platform also provides various ancillary services in order to complete the transaction. These ancillary services may be performed by various arms of the platform, or sometimes at the direct or indirect control of these arms.

The member research service module 145 provides the consumer agents 172 with tools to verify the credentials of the producers 120 and third-party service providers 130. The transaction service module 150 monitors the activities of the constituents to track the transaction workflow. The financial service module 160 ensures that the consumer 110 pays the producer 120 after the goods or services are received with satisfaction. In addition, the financial service module 160 may also provide working capital available to the producer 120 of the transaction group depending on the credit offered to the producer 120 by the platform. The platform management service module 180 enforces transaction policies, mediates disputes, and acts as the customer service clearinghouse for the transaction group.

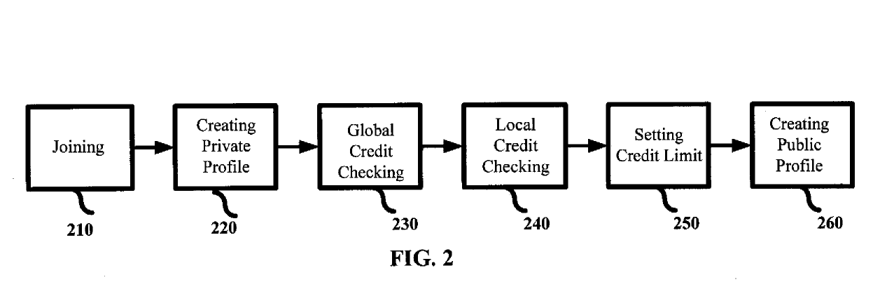

FIG. 2 illustrates a process of establishing a membership of the trade platform in accordance with one embodiment of the present invention. The trade platform wants to create a trustworthy business environment within which the credentials of the parties are all check upon to the satisfaction of the platform so that mutual trust can be automatically relied on by any party entering into a trade transaction. For example, a party joins the platform and becomes a member by registering through predetermined Internet-based tools of a communications network in step 210. The party may join the platform as a consumer, a producer, or a third-party service provider. While registering, the party has to provide certain information to the platform in order to be qualified. In step 220, the trade platform creates and maintains a standardized private profile for each of its members. The private profile contains but is not limited to information about a business entity's operations, management team, activities in the trade platform, and products sought or offered. All members are carefully categorized by their capability and role in any trade transaction. For example, parties may be classified parties as companies specializing in glass products, manufacturers of small electric motors, and insurance companies specializing in hazardous cargo transport. The more information is obtained by the platform, the more detailed classification can be done and more likely that the parties can be found to be a candidate for the transaction group.

The accuracy of a member's information is evaluated by agents of the transaction service facilitation unit within the trade platform in step 230. More specifically, the agents can verify the asset, debt, and trading history of a member based on feedback from producer agents or other accessible external sources around the world. In step 240, a survey is conducted internally among the consumer agents and producer agents located in close proximity of the party that is applying for the membership. This provides the best local information for checking the credential by “the words of the mouth” from local agents. The results from the survey will be used in the process of membership application for considering whether the platform will accept the applying party as a member of the platform.

In step 250, a Credit Limit (CL) is set up for a member of the trade platform according to its credit checked globally and locally. The member obtains a Credit Limit (CL) from the trade platform after the platform has done an extensive credit checking against the member. Sometimes, this checking is through platform accredited financial institutions, but various factors are considered, including credit history, banking history, etc. This credit establishment is different from traditional credit line establishment by a particular institute such a particular bank or credit card company in that multiple factors and feedbacks from multiple parties collectively determine the final allowed CL. Additionally, in line with standard credit cards, his or her CL rises or falls in relation to how the business is conducted within the trade platform as well as how much trade activities he or she is involved in at any given time. More so, the platform may, through financial institutions or itself, uses assets of the member at least partially guarantee the CL for the member. This assures that any party in the platform who enters a trade transaction can be trusted by other unfamiliar parties.

The CL system disclosed in this invention replaces the traditional LC system. The trade platform administrates the application of the CL and records the conduct of a member based on feedback from other members within the platform. This straightforward mechanism provides assurance to the members of the trade platform that their counterparties have been checked and are backed by the platform.

For decades, the LC system has been the mechanism of choice for payment in the international trade arena. Banks operating internationally with limited knowledge of counterparties were able to rely on the standard application of LCs to manage the release of funds in contracted trade arrangements. LCs are made for one particular contract by one financial institution. LCs are complex to administer in an increasingly automated world and are increasingly expensive to operate. International financial institutions rely on complex written instructions to manage how and when to release funds in a trade transaction, and there is no consideration whatsoever given to other factors such as the track record of participants, circumstances of a specific trade dispute, etc. In addition, the party that opens the LC generally holds all the power in the relationship. There is no element of financial risk management in the LC system and neither is there a real check and balance mechanism built into this payment structure.

In step 260, a public profile is created for a member at the end of the member registration process. Some member information, including trading history, comments from a counterparty, and Credit Limit, is accessible to all members and agents of the trade platform. Due to privacy laws of various countries, certain information may have to be withheld by the platform, but the platform intends to open up the record as transparent as possible so that there is no surprise to all participating members. As a result, the trade platform provides an open and trusted trading environment that all the members can reduce all unnecessary time to second guess whether they should do business with other members due to unfamiliarity with them.

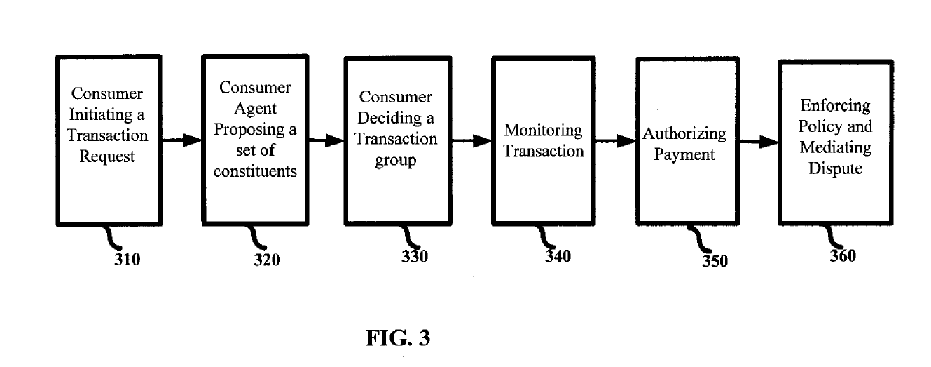

FIG. 3 illustrates a process of completing a trade transaction in the trade platform in accordance with one embodiment of the present invention. A consumer issues a transaction request to the trade platform by contacting his or her local consumer agent in step 310. The consumer agent gathers information with regard to the needs of the consumer, uses the member matching and research service modules provided by the trade platform to propose a list of potential constituents for a transaction group in step 320. In the same step, the consumer agent may consult with respective producer agents for producing the potential candidates for the transaction group. In step 330, based up the recommendation or analysis of the consumer agent, the consumer or the consumer agent with the full trust of the consumer selects the final constituents in the list that meet the requirements defined by the consumer. At this time, a transaction group is formed.

The transaction group includes the consumer and at least one producer, and possibly one or more third-party service provider. The producer offers goods or services to the consumer, who, in turn, pays for the received goods or services. The third-party service provider offers transaction support services, such as banking, trade finance, insurance, shipping, product testing, training, or web design.

In step 340, the consumer agent and the producer agent monitor the progress of the transaction with the transaction service module. By employing an event or transaction flow tracking system, a unified transaction engine in the transaction service module monitors required activities of the constituents of the transaction group and services based on data fed in from various participating parties in the trade platform.

Furthermore, the event tracking system creates the workflow of the transaction, links all aspects of the transaction information to the transaction workflow, and thus maintains a transaction workflow database. Consequently, the event tracking system is able to provide the transaction group with the detailed status of the requests and approvals from the constituents, the transaction status, the shipping status, the credit applications, the complaints, and the number of hits and queries to the member's web brochure, etc. The unified transaction engine brings together customer service, record keeping, contracting, and payment systems, in addition to linking the many third-party service providers into one seamless network-driven environment (e.g., an Internet driven environment) for the members of the trade platform.

In step 350, the financial service module provides a mechanism to guarantee the consumer a safe and easy way to pay for goods and services at the time they are received and accepted with satisfaction. It also provides the producer with the ability to finance working capital throughout a product or services' life cycle. The financial management service utilizes the CL based funding mechanism that provides satisfaction guarantee on all transactions conducted through the trade platform. All payments in relation to the transactions conducted in the trade platform are managed digitally.

The use of the CL system in the trade platform is rather straightforward. Members of the trade platform are free to commit themselves to financial transactions up to their Credit Limit—the same way as they make a purchase with standard credit card accounts. The trade platform prevents members from committing a transaction with amounts that go beyond their CL. In addition, both sides in the transaction will have the full value of a transaction deducted and added respectively from their Credit Limits.

In step 360, the platform management service module manages and monitors activities throughout the process of a transaction, and it is available to members for dealing with complaints and other questions. Issues such as disputes between a member and its agent and complaints about other members will be filed and managed by the platform management service module. In addition to being available on the Internet, there will be platform management service personnel in local service centers for conduct their respective job based on the policies of the platform.

In cases where a dispute occurs, the trade platform can, in some situations, freeze the value of the credit deducted or added respectively on both sides of the transaction, so neither side is able to profit from the dispute until a satisfactory resolution can be reached through negotiation, arbitration and/or the external court systems. Ultimately, the trade platform that controls the Credit Limits and various information about the transaction will have a lot of power in assisting the dispute resolution. This provides yet another check and balance on the parties that are active in the platform.

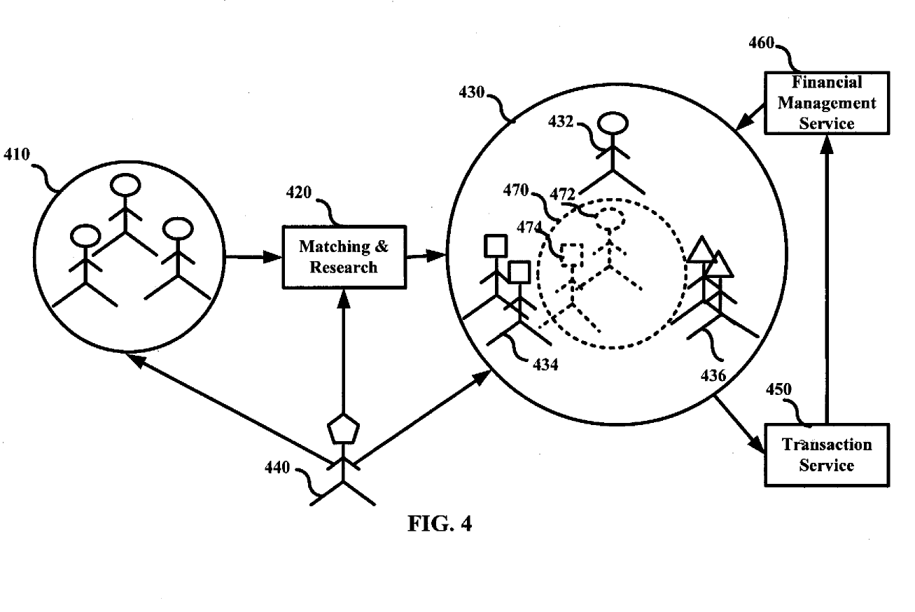

FIG. 4 shows a workflow of the trade operation using the trade platform in accordance with one embodiment of the present invention. A member 410 of the trade platform initiates a transaction request and creates a transaction group 430 with the assistance of a consumer agent 440 using a member matching service and research service 420. The transaction group 430 comprises a consumer 432, at least one producer 434, and probably one or more third-party service provider 436 who assists in transaction activities.

The credentials of the producers 434 are verified by the consumer agent 440 and using a member matching and research service 420. The agents conduct global and local credit checking including background screening, credit checking, performance analysis and screening, and other value-added services based on various predetermined sources of information including the member profile and the transaction history.

Once a transaction is established, a unified transaction engine in the transaction service module 450 monitors required activities of the constituents and services booked in the trade platform by employing an event tracking system. To facilitate a smooth transaction, agents under the control of the transaction service facilitation unit 470 are found in close proximity of the constituents of the transaction group 430. The trade platform also includes a series of central service centers located in major cities to act as hubs for supporting the activities of the business transactions. The central service centers are part of the transaction service facilitation unit 470 and provide a full support service for the trade platform.

The consumer agent 472 and producer agent 474 work closely with their clients in the transaction group and learn the preferences and nuances while assisting to progress transactions by managing every step of the transaction such as negotiations and sourcing translation services, and strive to generate transparent, long term, direct business relationships with their clients. Agent compensation is based entirely on the satisfaction of the consumer, not just based on a transaction value-based fee charged on the producer side of the transaction. Therefore, an agent works on behalf of its client. As a result, the economic and business interests of the agents are aligned with those of the respective consumers within the transaction group 430 while implementing successful transactions in a secured but transparent manner. For example, the price of goods or services offered by the producer may be open to the entire platform membership. Various charges added by the platform are also open to the membership. The transparency provided by the platform is to enhance the trust of the platform by each member. For example, when a consumer feels comfortable with the offered price by the platform and is willing to enter into a transaction, he may further request the platform to completely disclose to him the cost and fees of the transaction charged by various parties. He can do that by agreeing to pay a fee to the platform in case that he chooses to stop the transaction after reviewing the price structure. In this case, his CL will be automatically deducted. The platform may also offer him some alternative price structure. For example, if a consumer wants to have a product delivered after a short period of time, and the platform may offer him a different and lower price if the consumer would accept a later delivery date. This is especially practical when the consumer feels uncomfortable for any reason after seeing all the fees charged for the transaction.

The financial service module 460 provides the consumer 432 a safe and easy way to pay for goods and services at the time they are received and accepted while also providing the producer 434 with the ability to finance working capital throughout a product or services' life cycle. The producer 434 utilizes its deductable credit limit to obtain working capital finance from any financial institution operating in the trade platform. The deduction in the credit limit of the consumer 432 is a demonstration of the commitment to complete the transaction as agreed. More directly, once a Credit Limit is reached, the trade platform automatically limits a member from attempting to conduct additional transactions until sufficient utilized credit capacity is released through successful completion of active transactions or an increase of the credit limit.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A member-based trade management system for facilitating trade among one or more consumers and one or more producers by utilizing an agent service for the benefit of consumers, the system comprising:
a network-based communications module for storing and providing profile information about the one or more consumers, the one or more producers and one or more third-party service providers;
a member matching service module for presenting a plurality of candidates of a transaction group for participating in a trade transaction by comparing profile information of the one or more consumers with the one or more producers according to one or more predetermined criteria pertinent to the trade transaction;
a member research service module for examining credentials of the plurality of candidates for selecting constituents of the transaction group including at least one consumer and at least one producer;
a transaction service module for tracking a transaction workflow by monitoring required activities of the constituents of the transaction group for the trade transaction;
a financial service module for ensuring exchange of financial values between the consumer and the producer;
a platform management service module for mediating disputes arising from the trade transaction based one or more policies of the platform accepted by the constituents; and
at least one transaction service facilitation unit for providing one or more consumer agents and one or more producer agents access to data provided by the member research service module, the transaction service module, the financial service module, and the platform management service module for facilitating the trade transaction,
wherein at least one consumer agent is located close to the consumer of the transaction group and provides customized services to facilitate the trade transaction for benefits of the consumer,
wherein at least one producer agent is located close to the producer of the transaction group and provides local services for the benefit of the consumer to facilitate the trade transaction, and
wherein the trade transaction is only carried out among the constituents with checked credentials so as to reduce financial risks and disputes arising from the trade transaction.

2. The system of claim 1, wherein the member matching service module further presents at least one third-party service provider supporting the transaction.

3. The system of claim 1, wherein the member research service module, for examining credentials, conducts background screening, credit checking, and the transaction history analysis.

4. The system of claim 1, wherein the transaction service facilitation unit provides lateral credential check by one or more consumer agents located close to the producer.

5. The system of claim 1, wherein the transaction service module links all transaction related information generated by the constituents during the transaction.

6. The system of claim 1, wherein the financial service module establishes a credit limit for the consumer and the producer based on the profile information.

7. The system of claim 6, wherein the credit limit for the producer is partially guaranteed by assets of the producer.

8. The system of claim 6, wherein the credit limit for the constituents of the transaction group varies according to trade activities of the constituents.

9. The system of claim 1, wherein the transaction service facilitation unit allows the customer to choose the consumer agents based on their performances.

10. The system of claim 1, wherein the platform management service unit assist the consumer agent to manage and monitor activities of the transaction and to deal with complaints and questions generated by the consumer.

11. A method for facilitating trade between at least one consumer and at least one producer through an agent-based trade management platform, the method comprising:
receiving from at least one consumer a request for indicating a willingness to enter into a trade transaction with at least one producer in the platform based on one or more predetermined transaction criteria defined by the consumer;
handling the request by a local consumer agent by finding one or more suitable producers that meet the predetermined transaction criteria;
examining credentials of the one or more producers through one or more consumer agents for selecting one or more producers for the trade transaction;
upon receiving approval from the consumer, forming a transaction group with one or more constituents for completing the trade transaction within the platform, the constituents including a selected producer and at least one qualified service provider;
tracking the transaction through the consumer agent on behalf of the consumer by monitoring required activities of the constituents of the transaction group;
authoring the payment to the one or more producers for the goods and services received by the one or more consumers and financing working capital to the one or more producers; and
providing ancillary services for the transaction, and
wherein trade transactions are only entered among members of the platform with accessible profiles, which are examined by the consumer agent, so as reducing financial risk for the consumer, and
wherein the consumer agent services one or more consumers who have established a trusted relation therewith.

12. The method of claim 11, further comprising registering members for the platform by storing and processing profile information about the members and continuously updating the profile information based on activities engaged within the platform.

13. The method of claim 11, wherein the handling further includes examining credentials of the producers by the consumer agent based on the profile information.

14. The method of claim 11, wherein the consumer agents are compensated based on satisfaction of the consumer.

15. The method of claim 11, wherein the local consumer agent and the producer agent locate in different geographical regions.

16. The method of claim 11, wherein the trade transaction involves members from different countries.

17. The method of claim 11, wherein the providing ancillary services further includes acting as a customer service clearinghouse for the transaction group.

18. The method of claim 11, wherein the providing ancillary services further includes providing the producer a predetermined amount of working capital based on the credential thereof.

19. The method of claim 11, wherein the providing ancillary services further includes providing enforcing one or more transaction policies defined by the platform against the constituents of the transaction group.

20. A method for facilitating trade between at least one consumer and at least one producer by at least one consumer agent and at least one producer agent, the method comprising:
receiving from at least one consumer a request for indicating a willingness to enter into a trade transaction with at least one producer in the platform based on one or more predetermined transaction criteria defined by the consumer;
handling the request by finding one or more suitable producers that meet the predetermined transaction criteria;
examining credentials of the one or more producers for the trade transaction; and
upon receiving approval from the consumer, tracking the transaction on behalf of the consumer by monitoring required activities of the constituents of the transaction group,
wherein the consumer enjoys a successful transaction with the assistance of the at least one consumer agent and the at least one producer agent whose are compensated based on the satisfaction of their clients.

21. The method of claim 20, further comprising processing profile information about the members and continuously updating the profile information based on activities within the platform.

22. The method of claim 20, wherein the local consumer agent and the producer agent are located in different geographical regions.

23. The method of claim 20, wherein the local consumer agent meets his or her clients face-to-face to understand their needs and resolve any trading issues.

24. The method of claim 20, wherein the local consumer agent consults with other domain agents, such as travel agents and insurance agents, and coordinate various services to facilitate transactions.

25. The method of claim 20, wherein the producer agent monitors the progress of transactions and the quality of goods and services provided by producers.

26. The method of claim 20, wherein the producer agent initiates formal inquires into a producer's conduct when complaints about goods and services provided by the producer exceed a predetermined threshold.

27. The method of claim 20, wherein the handling further includes examining credentials of the producers by the consumer agent based on the profile information.
